(19) United States
(12) Patent Application Publication
(10) Pub. No.: US 2025/0104199 A1
(43) Pub. Date: Mar. 27, 2025

(54) METHOD AND APPARATUS FOR DENOISING A TOMOGRAPHY RECORDING

(71) Applicant: Siemens Healthineers AG, Forchheim (DE)

(72) Inventors: Philipp Roser, Erlangen (DE); Christopher Syben, Cadolzburg (DE); Alois Regensburger, Poxdorf (DE)

(21) Appl. No.: 18/830,231

(22) Filed: Sep. 10, 2024

(30) Foreign Application Priority Data
Sep. 21, 2023 (DE) 10 2023 209 197.6

(51) Int. Cl. G06T 5/70

(52) U.S. Cl. CPC G06T 5/70; G06T 2207/10116

(57) ABSTRACT

A method for denoising a tomography recording with a plurality of projection images includes: selecting an action projection image to be denoised; selecting a plurality of reference projection images having recording angles that lie in a range of the recording angle of the action projection image and/or an opposite recording angle; adapting a binning of the reference projection images to the action projection image so that the reference projection images correspond to the projection geometry of the action projection image; and denoising the action projection image based on a noise of the reference projection images.

The present patent document claims the benefit of German Patent Application No. 10 2023 209 197.6, filed Sep. 21, 2023, which is hereby incorporated by reference in its entirety.

### TECHNICAL FIELD

The disclosure relates to a method and an apparatus for denoising a tomography recording, a control facility for a tomography system, and a tomography system.

### BACKGROUND

Noise is a problem associated with X-ray-based imaging. Noise is in particular a limiting factor in cone-beam computed tomography (CBCT) with a conical beam. The aim is to achieve sufficient image quality and quantitative Hounsfield units (HUs) despite the noise.

There are already several noise reduction techniques for improving image quality in existence. Common techniques include, inter alia, filtering, neural networks (for example, Noise2Noise or Stable Diffusion) or iterative reconstruction. There are different types of filters for filtering, such as, for example, averaging filters, Gaussian filters, bilateral filters, Savitzky-Golay filters, Perona-Malik filters, or filters with anisotropic diffusion. It is also possible to perform an initial reconstruction, calculate a digitally rendered X-ray image for each projection, and then use this as a pilot image for noise suppression.

Although these methods may reduce noise in images, the fundamental problem of noise remains.

### SUMMARY AND DESCRIPTION

It is an object of the present disclosure to provide a method and apparatus for denoising a tomography recording, a corresponding control facility for controlling a tomography system, and a tomography system with which the above-described disadvantages are avoided.

This object is achieved by a method, an apparatus, a control facility, and a tomography system as described herein. The scope of the present disclosure is defined solely by the appended claims and is not affected to any degree by the statements within this summary. The present embodiments may obviate one or more of the drawbacks or limitations in the related art.

The disclosure is concerned with noise suppression in the projection space in order to improve image quality in the reconstructed image slices or image volumes for a tomography recording. A tomography recording includes a plurality of projection images recorded from different angles. These images are then used to reconstruct a result image that may map the recorded object in 3D. Such a result image may include a stack of slice images but may also be formed from voxels in a 3D volume.

A method is used to denoise a tomography recording. This includes a plurality of projection images recorded from different recording angles. Herein, recording angles that only differ slightly from one another may also occur, for example, in cone-beam computed tomography (CBCT), a high-resolution computed tomography technique (“CT”) using a conical X-ray beam. Hereinafter, the angles are regarded as different recording angles because they belong to different recordings (and in practice the same angles are never normally exactly identical for two different projection cycles).

The method includes: selecting an action projection image to be denoised; selecting a plurality of reference projection images whose recording angles lie in the range of the recording angle of the action projection image and/or the opposite (i.e., rotated by 180°) recording angle; adapting the binning of the reference projection images to the action projection image so that they correspond to the projection geometry of the action projection image; and denoising the action projection image based on a noise of the reference projection images.

As stated above, a tomography recording includes a plurality of projection images recorded from different recording angles. It is possible for only one of these images to be denoised, but, in certain examples, each of these images may be denoised. Since all of these images were taken with the same recording unit, their noise patterns follow the same physical processes, even if they are completely random.

This allows, for example, a time-resolved recording of the same projection to be averaged over time. Although the noise of each image is different, the more images available, the more accurately the actual expected value for each pixel may be approximated by arithmetic averaging.

The method is concerned with the denoising of a projection image, which is referred to as an “action projection image” in order to indicate that the denoising action is performed with this projection image. To denoise a plurality of projection images, the method is simply applied to each projection image to be denoised. Therefore, the action projection image to be denoised is selected at the start of the method. This action projection image was recorded at a specific recording angle.

After selecting the action projection image, a plurality of reference projection images is selected. Herein, the reference projection images are not selected at random. Instead, only those whose recording angles are in the range of the recording angle of the action projection image and/or the opposite recording angle are selected. The range may not deviate by more than 10° from the recording angle (or the angle 180° thereto), by no more than 5°, or by no more than 1°.

At least two reference projection images are selected, (e.g., at least 4 images or at least 6 images). Conversely, to optimize the computing time, the number may be limited to at most 20 images or at most 10 images.

With regard to the angle-dependent image selection, reference projection images from a recording angle range that is approximately 180° away, i.e., opposite, may be problematic, since they may contain compressed image information, in particular when recording with a non-parallel X-ray beam, since, with non-parallel beams, objects that are further away are not mapped true to scale to objects that are closer. In certain examples, at least when recording with non-parallel beams, only reference projection images are used with recording angles that are in the range of the recording angle of the action projection image and not in the range of the opposite recording angle.

However, for opposite recording angles, a special method for compiling projection images may be used that exploits the fact that conical beams have pixels or rows of pixels in adjacent projection images that are identical to the corresponding pixels in opposite images. Starting from the action projection image, its equivalent (for a further reference projection image) may be compiled from pixels from different opposite projection images by selecting the opposite identically corresponding pixels or rows of pixels in each case. In the same way, equivalents of the reference projection images may also be compiled from pixels of opposite projection images.

Herein, the reference projection images may be directly adjacent images. The smaller the difference between the recording angles, the more similar the projection images.

If two projection images were recorded with different recording angles, the image information differs because the subject being recorded is distorted to a different degree. If, for example, two points are recorded that are at different distances from the detector, they will be at different distances from each other in the projection images. However, this is a geometric effect that may be compensated with the known recording angles by adapting the binning.

Rebinning is known in the prior art (see, for example, S. Syben et al. “Known operator learning enables constrained projection geometry conversion: Parallel to cone-beam for hybrid MR/X-ray imaging,” IEEE Transactions on Medical Imaging; Volume: 39, Issue: Nov. 11, 2020). During binning, in each case, a plurality of adjacent pixel signals of an X-ray detector is combined. Rebinning changes the spatial assignment of pixel signals of an X-ray detector to positions in the result image. The change may include translations, rotations, or more complex assignments of pixel signals of the original image to positions in the result image. Rebinning may be based on 3D points in space. However, rebinning based on line integrals is advantageous. In the context of reconstruction, a line integral refers to summed attenuation values of the object being irradiated along a beam (in a pixel). These result from logarithmization followed by multiplication with ‘−1’ from the X-ray intensities measured at the detector.

Adapting the binning (“rebinning”) of the reference projection images to the action projection image suppresses distortion. Adaptation takes place in such a way that they correspond to the projection geometry of the action projection image, i.e., as if they had been taken from the same recording angles.

With respect to noise suppression, there is a projective component in additional to the temporal component. There is only one single projection for each projection geometry. However, rebinning generates further (identical) projections from adjacent projections for each projection. During rebinning, a weighted sum of the adjacent projections is in particular determined for each pixel. This weighted sum results in a less noisy or smoother image. This may then be selected as a default for a guided filter, for example, in order to denoise the actual projection.

In certain examples, images recorded from the same recording angle may be used for denoising and then, for example, an average of the values of the individual pixels calculated. However, these images are not usually available for tomography. After rebinning, however, the reference projection images may be used very effectively for denoising the action projection image, since their geometry is very similar to the action projection image. The action projection image may also be denoised based on the noise of the reference projection images (adapted by rebinning).

In particular, a virtual X-ray projection Vᵢ (“guidance position image”) may be estimated for the action projection image Pᵢ of a CT recording by relinking adjacent reference projection images Pⱼ (where j≠i) with the projection geometry of Pᵢ by rebinning. This virtual projection Vᵢ is then used as a guidance image for a common filtering act, for example, using a common bilateral filter, or as a mask of a guided filter. Because the virtual image Vᵢ is estimated from a plurality of reference projection images by rebinning (for example, by geometric or temporal averaging), it has a similar noise pattern and (due to the plurality of reference projection images) less noise. Here, the averaging image values may correspond to temporal averaging, because the reference projection images were recorded one after the other. This makes it possible to use the reference projection images or virtual projections derived therefrom for denoising an action projection image. Here, the number of reference projection images used may depend on the angular sampling of the trajectory.

The reference projection images, or virtual projections derived therefrom may be accurate for the middle detector row (e.g., the middle pixel row in the projection images) and may become less accurate toward the top and bottom of the detector. In combination with more advanced and data-complete trajectories, (e.g., sine spin or dual source long object with overlapping detectors for two detector planes A and B), more accurate rebinning of non-central detector rows is possible.

The quality of the reference projection images adapted by rebinning, or the virtual projection created therefrom as a guidance projection image, also depends on the rebinning algorithm used. An embodiment of rebinning is beam-for-beam rebinning in the projection area. Conventional beam-to-beam rebinning refers to the approximation of a beam (pixel) under a new target projection geometry by interpolating beams (pixels) of the recorded projection geometry/geometries, for example, by bilinear interpolation. In such a rebinning algorithm, the interpolation strategy (for example, closest neighbor, linear, bilinear, cubic, etc.) may be selected according to the current application because this has a major influence on the virtual projection and the current noise pattern.

Another possibility includes using a tomography-based rebinning approach, which is based on a learned filter for the specific tomographic rebinning case. Tomography-based or tomography-guided rebinning refers to reconstruction by, for example, filtered back projection with less projection and subsequent forward projection along a new projection geometry. Such an algorithm does not degenerate as quickly as beam-for-beam rebinning in the case of missing beams (due to the incompleteness of the data/trajectory used). In addition, a tomographic rebinning approach allows optimization for a specific/optimal noise pattern in the pilot image in order to maximize the usability of the virtual projection.

An apparatus for denoising a tomography recording with a plurality of projection images may be configured to perform a method as disclosed here. The apparatus includes: a selection unit configured to select an action projection image to be denoised and to select a plurality of reference projection images whose recording angles lie in the range of the recording angle of the action projection image and/or the opposite recording angle; an adaptation unit configured to adapt the binning of the reference projection images to the action projection image so that they correspond to the projection geometry of the action projection image; and a denoising unit configured to denoise the action projection image based on the noise of the reference projection images.

The functions of the components have already been described in more detail above in the course of the method.

A control facility for a tomography system includes an apparatus and/or is configured to perform a method as disclosed herein.

A tomography system may be an angiography system or a CT system and include a control facility as disclosed herein.

A large part of the aforementioned components may be implemented in whole or partially in the form of software modules in a processor of a corresponding computing system, for example, by a control facility of a computed tomography system. A software-based implementation has the advantage that previously used computing systems may also be easily retrofitted by a software update in order to operate in the manner according to the disclosure. In this respect, the object is also achieved by a corresponding computer program product with a computer program, which may be loaded directly into a computing system, with program sections for executing the acts of the method, at least the acts that may be executed by a computer when the program is executed in the computing system. In addition to the computer program, such a computer program product may include additional items, such as documentation and/or additional components, including hardware components, such as hardware keys (e.g., dongles, etc.), for using the software.

A computer-readable medium, for example, a memory stick, a hard disk, or another kind of transportable or permanently installed data carrier on which the program sections of the computer program that may be read in and executed by a computing system are stored may be used for transport to the computing system or the control facility and/or for storage on or in the computing system or the control facility. For this purpose, the computing system may have one or more interacting microprocessors or the like.

Further particularly advantageous embodiments and developments of the disclosure result from the dependent claims and the following description, wherein the claims of one claim category may also be developed analogously to the claims and descriptive parts to form another claim category and in particular individual features of different exemplary embodiments or variants may also be combined to form new exemplary embodiments or variants.

According to a method, the recording angles of the reference projection images may differ from the recording angle of the action projection image by at most 10°, by at most 5°, or by at most 1°. For a good match after rebinning, the recording angles of the reference projection images may be as close as possible to that of the action projection image. In certain examples, the reference projection images selected are those whose recording angles are the next larger and/or next smaller to the recording angle of the action projection image or the opposite recording angle. Therefore, the direct neighbors of the action image may be selected as reference projection images (with regard to the recording angles).

For a reference projection image (e.g., each reference projection image) from a relative recording angle A to the recording angle of the action projection image, a further reference projection image with the relative recording angle −A to the recording angle of the action projection image is selected. This means that, if a projection image with a recording angle to the right (or trailing) of the action projection image is selected, a projection image with a corresponding recording angle to the left (or leading) is selected as a reference projection image. The two selected projection images then so to speak form a pair of reference position images.

The information from these pairs of reference projection images, (e.g., their pixel values or image information), may then be used to adapt the binning. Such pairs may be used to estimate the relative depth of structures using parallax effects. This information may be valuable for rebinning.

In certain examples, reference projection images are combined to form one virtual guidance projection image. This may be done by averaging the image values, which corresponds to temporal averaging, because the projection images were recorded one after the other. Herein, geometric averaging may be used, which may result in bilinear interpolation. The advantage of combining into a guidance projection image is that it contains the image information from a plurality of reference projection images and accordingly be designed to be low-noise. The action projection image and the guidance projection image may be averaged during denoising. Alternatively or additionally, for denoising, a trained machine-learning model may be used that has been trained on the noise properties of action projection images relative to the guidance projection image.

The action projection image may be denoised using a bilateral filter, the filter kernel of which is based on the reference projection images or which uses the reference projection images as guidance images. Such a bilateral filter may also use the aforementioned guidance projection image as the guidance image.

The action projection image may be denoised using a guided filter, the guidance image of which is based on the reference projection images. In guided filtering, characteristics of the guidance image are taken into account when filtering the input image and are retained as far as possible.

Such a guided filter may also use the aforementioned guidance projection image as a mask image.

In certain examples, when recording the projection images, further projection images are recorded at further recording angles before the first projection image and/or after the last projection image and used for denoising, but may not be used for image reconstruction. This makes it possible to compensate for the effect that the projection images from the outermost recording angles have no neighbors (or fewer neighbors) on one side. For this purpose, projection images may be recorded at a larger angular range than the angular range defined for a recording. This embodiment is particularly advantageous if the entire angular range of the recording is less than 360°, or if the patient is moved during the recording (for example, with spiral CT).

In certain examples, a previously denoised action projection image is used as a reference projection image for denoising another action projection image. The method may be applied multiple times in order to denoise a plurality of images. This obtains more and more denoised images. Because these correspond to the initial projection images at exactly this point, they may also be selected as reference projection images. Therefore, the method may be executed multiple times in succession and projection images denoised with previous executions of the method are selected as reference images. If the method is performed successively by selecting the next recording angle in each case, then very soon only denoised images remain on one side of the current action projection image.

According to a method, the binning of the reference projection images may be adapted to the action projection image using a beam-for-beam rebinning approach, (e.g., a beam-for-beam rebinning approach with trainable weights for redundant beams).

According to a method, the binning of the reference projection images may be adapted to the action projection image using a tomographic rebinning approach, (e.g., with trainable redundancy weights and/or a trainable reconstruction kernel and/or trainable distance weighting).

According to a method, to reconstruct a target projection image, the tomography recording may be carried out with a conical beam. A reference projection image is then compiled from image elements of a plurality of projection images. It may be compiled from projection images whose recording angles originate from an area lying opposite the recording angle of the action projection image.

An example of a method in this regard includes: selecting a target projection image from the recording angle range of the action projection image (thus, the target projection image may also correspond to a reference projection image) whose pixels are to be simulated; ascertaining the recording geometry of the target projection image by ascertaining the respective beam path for each pixel at the recording angle of the target projection image; ascertaining, for each pixel of the target projection image, which pixel of the plurality of projection images corresponds to an inverted beam path through the object (these two pixels, which lie on the same inverted beam path, may theoretically have the same image values); selecting this pixel as the corresponding pixel for the target projection image (i.e., the target projection image may be rasterized pixel by pixel and these (empty) pixels of the target projection image may be filled with the pixel values of the corresponding pixels of the plurality of projection images); and using the target projection image as a reference projection image.

The target projection image is an image whose recording geometry corresponds to an image from the area of the action projection image. Therefore, it “lies” on the side of the action projection image but is formed from opposite images (inverted beam path).

In certain examples, AI based methods (AI: “artificial intelligence”) may be for the method. Artificial intelligence is based on the principle of machine-based learning and may be performed with an algorithm that is capable of learning and has been trained accordingly. Machine-based learning is often called “machine learning,” wherein this also includes the principle of “deep learning.”

In certain examples, components of the disclosure are available as a “cloud service.” Such a cloud service is used to process data, in particular by artificial intelligence but may also be a service based on conventional algorithms or a service in which an evaluation by humans takes place in the background. A cloud service (hereinafter also referred to as “cloud” for short) is an IT infrastructure in which, for example, storage space or computing power and/or application software is made available via a network. Herein, communication between the user and the cloud takes place by data interfaces and/or data transmission protocols. In the present case, the cloud service may provide both computing power and application software.

In certain methods, data may be provided to the cloud service via the network. This includes a computing system, (e.g., a computer cluster), which may not include the user's local computer. This cloud may in particular be provided by the medical facility that also provides the medical technology systems. For example, the data from an image recording is sent to a remote computer system (the cloud) via a RIS (radiology information system) or PACS (picture archive and communication system). In certain examples, the computing system, the cloud, the network, and the medical technology system represent a cluster in the sense of data technology. Herein, the method may be implemented in the network by a command constellation. The data calculated in the cloud (“result data”) is later sent back to the user's local computer via the network.

### BRIEF DESCRIPTION OF THE DRAWINGS

The disclosure is explained again in more detail below with reference to the appended figures and with reference to exemplary embodiments. Herein, the same components in the different figures are provided with identical reference symbols. The figures are not to scale.

FIG. 1 depicts an example of a tomography system having an apparatus.

FIG. 2 depicts an example of acts of the method.

### DETAILED DESCRIPTION

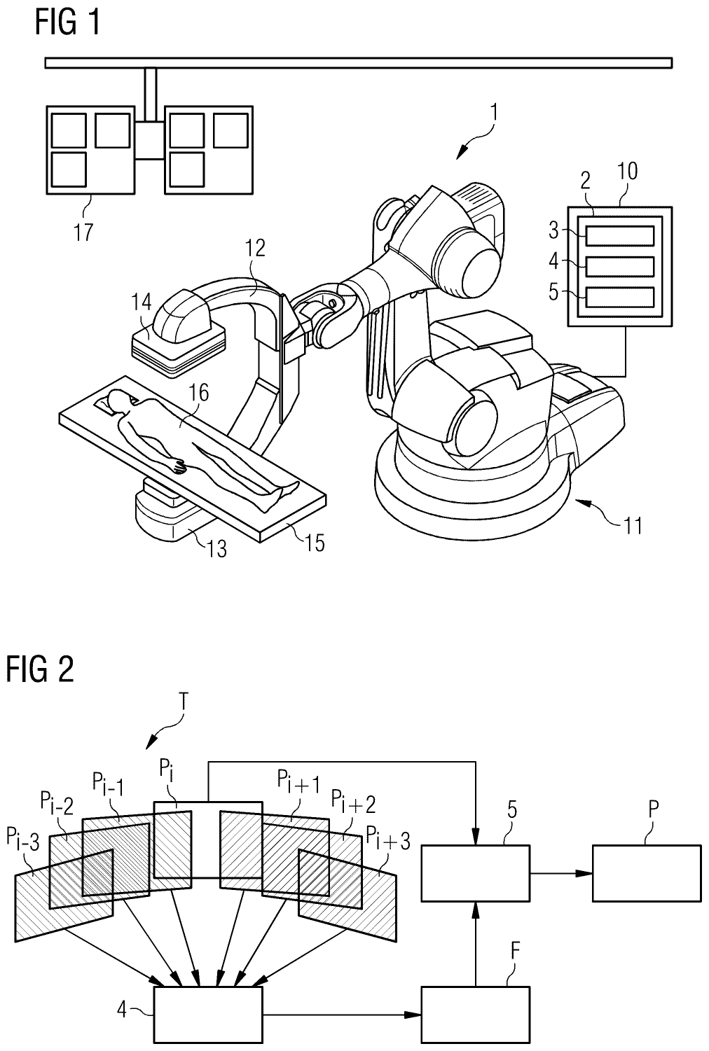

FIG. 1 shows a tomography system 1 depicted by way of example in the form of an angiography system with a C-arm 12 held by a stand 11 in the form of a six-axis industrial or articulated-arm robot at the ends of which an X-ray radiation source, for example, an X-ray emitter 13 with an X-ray tube and a collimator, and an X-ray image detector 14 are attached as an image recording unit.

The articulated-arm robot, which may have six axes of rotation and thus six degrees of freedom, may be used to spatially adjust the C-arm 12 as desired, (e.g., by rotating it about a center of rotation between the X-ray emitter 13 and the X-ray image detector 14). The tomography system 1 may be rotated about centers of rotation and axes of rotation in the C-arm plane of the X-ray image detector 14.

The articulated-arm robot has a base frame, which may be permanently mounted on a floor. A carousel is attached to this so that the carousel may rotate about a first axis of rotation. A robot swing arm is attached to the carousel so that it may pivot about a second axis of rotation to which a robot arm is attached so that it may rotate about a third axis of rotation. A robot hand is attached to the end of the robot arm so that it may rotate about a fourth axis of rotation. The robot hand has a fastening element for the C-arm 12, which may be pivoted about a fifth axis of rotation and rotated about a sixth axis of rotation perpendicular thereto.

The implementation of the X-ray diagnostic facility is not dependent on industrial robots. Conventional C-arm devices may also be used.

The X-ray image detector 14 may be a rectangular or square flat semiconductor detector that may be made of amorphous silicon (a-Si). However, integrating and counting CMOS detectors may also be used.

A patient to be examined 16 is located in the beam path of the X-ray emitter 13 on a tabletop 15 of a patient positioning table as the examination object 16. A control facility 10, which receives and processes the image signals from the X-ray image detector 14 (control elements are not depicted here) is attached to the X-ray diagnostic facility. The X-ray images may then be viewed on displays of a monitor 17.

The system control unit 10 furthermore includes an apparatus 2 with a selection unit 3, an adaptation unit 4, and a denoising unit 5. The function of this apparatus and its units is explained below with reference to FIG. 2.

FIG. 2 is a sketch of a method for denoising a tomography recording T with a plurality of projection images. Some projection images Pᵢ₋₃, Pᵢ₋₂, Pᵢ₋₁, Pᵢ, Pᵢ₊₁, Pᵢ₊₂, Pᵢ₊₃ of this tomography recording T are shown on the left. The selection unit 3 has selected the middle image as the action projection image Pᵢ. This action projection image Pᵢ is to be denoised. Furthermore, the selection unit 3 has selected a series of reference projection images Pᵢ₋₃, Pᵢ₋₂, Pᵢ₋₁, Pᵢ₊₁, Pᵢ₊₂, Pᵢ₊₃ which are adjacent to the action projection image Pᵢ, i.e., whose recording angles are exactly next to the recording angle of the action projection image Pᵢ.

There may be three pairs of reference projection images Pᵢ₋₃, Pᵢ₋₂, Pᵢ₋₁, Pᵢ₊₁, Pᵢ₊₂, Pᵢ₊₃, which, in terms of magnitude, have exactly the same relative recording angle to the recording angle of the action projection image Pᵢ.

The different shape of the reference projection images Pᵢ₋₃, Pᵢ₋₂, Pᵢ₋₁, Pᵢ₊₁, Pᵢ₊₂, Pᵢ₊₃ indicates that they reproduce the recording area with some distortion due to the slightly different recording angles compared to the action projection image Pᵢ. To compensate this, the selected reference projection images Pᵢ₋₃, Pᵢ₋₂, Pᵢ₋₁, Pᵢ₊₁, Pᵢ₊₂, Pᵢ₊₃ are sent to the adaptation unit 4.

In the adaptation unit 4, the binning of the reference projection images Pᵢ₋₃, Pᵢ₋₂, Pᵢ₋₁, Pᵢ₊₁, Pᵢ₊₂, Pᵢ₊₃ is adapted to the action projection image Pᵢ such that they correspond to the projection geometry of the action projection image Pᵢ.

In this example, the reference projection images Pᵢ₋₃, Pᵢ₋₂, Pᵢ₋₁, Pᵢ₊₁, Pᵢ₊₂, Pᵢ₊₃ are combined to form a virtual guidance projection image F. The rectangular shape of this guidance projection image F is intended to indicate that the reference projection images Pᵢ₋₃, Pᵢ₋₂, Pᵢ₋₁, Pᵢ₊₁, Pᵢ₊₂, Pᵢ₊₃ have been adapted to the geometry of the action projection image Pᵢ by rebinning.

The guidance projection image F is now sent to the denoising unit 5 together with the action projection image Pᵢ (see arrows from above and below). There, the action projection image Pᵢ is then denoised based on a noise of the guidance projection image F. This may be achieved by using a bilateral filter the filter kernel of which is based on the guidance projection image F. However, it is also possible to use a guided filter the mask image of which is based on the guidance projection image F.

A denoised projection image P is then obtained. Repeating this process enables the entire tomography recording T to be denoised. For this purpose, a previously denoised action projection image Pᵢ may be used as a reference projection image Pᵢ₋₃, Pᵢ₋₂, Pᵢ₋₁, Pᵢ₊₁, Pᵢ₊₂, Pᵢ₊₃ for denoising another action projection image Pᵢ.

Finally, reference is made once again to the fact that the figures described in detail above are merely exemplary embodiments which may be modified in a wide variety of ways without departing from the scope of the disclosure. Furthermore, the use of the indefinite articles “a” or “an” does not preclude the possibility that the features in question may also be present on a multiple basis. Likewise, the terms “unit” and “device” do not preclude the possibility that the components in question may include a plurality of interacting sub-components which may also be spatially distributed. The expression “a number” may be understood to mean “at least one.” Independent of the grammatical term usage, individuals with male, female or other gender identities are included within the term.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for denoising a tomography recording with a plurality of projection images, the method comprising:
selecting an action projection image to be denoised;
selecting reference projection images having recording angles that lie in a range of a recording angle of the action projection image and/or an opposite recording angle;
adapting a binning of the reference projection images to the action projection image so that the reference projection images correspond to a projection geometry of the action projection image; and
denoising the action projection image based on a noise of the reference projection images.

2. The method of claim 1, wherein the recording angles of the selected reference projection images differ from the recording angle of the action projection image by at most 10°, and
wherein the reference projection images have recording angles that are a next larger and/or a next smaller to the recording angle of the action projection image or the opposite recording angle.

3. The method of claim 1, wherein, for at least one reference projection image of the reference projection images with a relative recording angle to the recording angle of the action projection image, a further reference projection image with the relative recording angle to the recording angle of the action projection image is selected to provide at least one pair of reference projection images, and
wherein information from the at least one pair of reference projection images is used to adapt the binning.

4. The method of claim 1, wherein the reference projection images are combined to form one virtual guidance projection image, and wherein the action projection image and the virtual guidance projection image are averaged during denoising, and/or
wherein, for denoising, a machine-learning model is used that has been trained on noise properties of action projection images relative to the virtual guidance projection image.

5. The method of claim 1, wherein, for denoising the action projection image, a bilateral filter is used, and
wherein a filter kernel of which is based on the reference projection images or which uses the reference projection images as guidance images and/or a guided filter is used, a mask image of which is based on the reference projection images.

6. The method of claim 1, wherein, when recording the projection images, further projection images are recorded at further recording angles before a first projection image and/or after a last projection image and used for denoising, and
wherein the further projection images are not used for image reconstruction.

7. The method of claim 6, wherein the projection images are recorded at a larger angular range than an angular range defined for a recording.

8. The method of claim 1, wherein a previously denoised action projection image is used as a reference projection image for denoising another action projection image.

9. The method of claim 1, wherein the adapting of the binning comprises:
using a beam-for-beam rebinning approach, and/or
using a tomographic rebinning approach.

10. The method of claim 9, wherein the beam-for-beam rebinning approach uses trainable weights for redundant beams.

11. The method of claim 9, wherein the tomographic rebinning approach uses trainable redundancy weights, a trainable reconstruction kernel, trainable distance weighting, or a combination thereof.

12. The method of claim 1, further comprising:
reconstructing the tomography recording from projection images recorded with a conical beam; and
compiling a reference projection image from image elements of a plurality of projection images.

13. The method of claim 12, wherein the compiling of the reference projection image is from projection images having recording angles that originate from an area lying opposite the recording angle of the action projection image.

14. The method of claim 13, wherein the compiling of the reference projection image comprises:
selecting a target projection image from a recording angle range of the action projection image having pixels to be simulated;
ascertaining recording geometry of the target projection image by ascertaining a respective beam path for each pixel at the recording angle of the target projection image;
ascertaining, for each pixel of the target projection image, which pixel of the plurality of projection images corresponds to an inverted beam path through an object;
selecting the pixel corresponding to the inverted beam path as a corresponding pixel for the target projection image; and
using the target projection image as the reference projection image.

15. An apparatus for denoising a tomography recording with a plurality of projection images, the apparatus comprising:
a selection unit configured to select an action projection image to be denoised and to select reference projection images having recording angles that lie in a range of a recording angle of the action projection image and/or an opposite recording angle;
an adaptation unit configured to adapt a binning of the reference projection images to the action projection image so that the reference projection images correspond to a projection geometry of the action projection image; and
a denoising unit configured to denoise the action projection image based on a noise of the reference projection images.

16. A system comprising:
a control facility having an apparatus for denoising a tomography recording with a plurality of projection images, wherein the apparatus comprises:
a selection unit configured to select an action projection image to be denoised and to select reference projection images having recording angles that lie in a range of a recording angle of the action projection image and/or an opposite recording angle;
an adaptation unit configured to adapt a binning of the reference projection images to the action projection image so that the reference projection images correspond to a projection geometry of the action projection image; and
a denoising unit configured to denoise the action projection image based on a noise of the reference projection images.

17. The system of claim 16, wherein the system is a tomography system.

18. The system of claim 17, wherein the tomography system is an angiography system or a computed tomography system.
